(19) United States
(12) Patent Application Publication
(10) Pub. No.: US 2026/0127094 A1
(43) Pub. Date: May 7, 2026

(54) METHOD AND DEVICE FOR MODIFYING A SOFTWARE CODE FILE

(71) Applicant: Orange, Issy-les-Moulineaux (FR)

(72) Inventors: Nimisha Gupta, GURGAON (IN); Manish Sharma, GURGAON (IN); Vivek Kaushik, GURGAON (IN); Rajhas Balaraman, GURGAON (IN); Himanshu Pratap, GURGAON (IN)

(21) Appl. No.: 18/878,364

(22) PCT Filed: Jun. 21, 2023
(86) PCT No.: PCT/EP2023/066893

§ 371 Date: Dec. 23, 2024

(30) Foreign Application Priority Data
Jun. 30, 2022 (IN) 202211037703

(51) Int. Cl. G06F 11/362

(52) U.S. Cl. CPC G06F 11/3624

(57) ABSTRACT

A method for modifying a software code file containing source code is described, the method including automatically performing: execution of the software code file; parsing a log file obtained further to the execution of the software code contained in the software code file, to identify at least a data structure enabling the identification of one error message generated during the execution of the software code; identifying, in the software code file, a location of software code lines corresponding to the at least one error message, the location being retrieved from information contained in the data structure; matching information related to the at least one error message with patch source code associated with the error message, the patch source code contained in a patch source code file or a patch database; and modifying software code lines in the software code file at the identified location, using the patch source code.

### FIELD OF THE INVENTION

The present invention relates to the field of error correction during software testing.

### TECHNICAL BACKGROUND

Software developers usually manually review the execution of source codes in order to find errors and correct them manually. They apply patch code to fix manually the errors and then execute again and again the source code to check whether the error has been corrected and move to the next one. It is common that exceptions related to the environment and platform occur quite frequently and fixing these code exceptions take a lot of time and renders the process of error fixing challenging and time consuming. Moreover, it can happen that test engineers lack experience to be able to find easily the errors and the solution to correct them. In addition, usually source code contains millions of codes lines and this makes the process of manual error correction burdensome.

More and more software developers need to produce complex source code and in less and less time and for this reason, spending time in debugging software codes is a waste of time and should be avoided as much as possible to improve deliverables.

The present invention aims at solving at least one of these drawbacks by providing an automatic solution for software error correction that can help software developers or testers accelerate the test phase of a software.

### SUMMARY OF THE INVENTION

The present invention provides a method for modifying a software code file containing source code comprising automatic run of
execution of said software code file,
parsing a log file obtained further to the execution of the software code contained in said software code file, to identify at least a data structure enabling the identification of one error message generated during the execution of said software code,
identifying, in the software code file, a location of software code lines corresponding to said at least one error message, said location being retrieved from information contained in said data structure,
matching information related to said at least one error message with patch source code associated with said error message, said patch source code being contained in a patch source code file or a patch database,
modifying software code lines in said software code file at the identified location, using said patch source code.

According to some embodiments, said patch source code comprises an action and said modifying software code lines modify software code lines according to said action.

According to some embodiments, the method comprises
structuring said software code file in tree structure
searching said at least one error message based on an index search in said tree-structured log file.

According to some embodiments, the method comprises structuring said software code file in tree structure.

According to some embodiments, the method comprises, creating for the at least one data structure, from said tree-structured log file, an error object comprising an error identifier and description information associated with said error object and said location information.

According to some embodiments, said matching comprises
parsing said patch source code file or patch database to retrieve at least one patch source code according to similarity measurement between said error object and said patch source code,
associating a confidence score to said at least retrieved patch source code,
when said at least one confidence score is above a determined confidence score, selecting patch source code according to the confidence score,
correcting said software code lines associated with said data structure by said selected patch source code using location information of said error object.

According to some embodiments, said modifying said software code lines correct said software code lines in said tree-structured software code file.

According to some embodiments, the method comprises, further to the correcting
executing said software code file
parsing said obtained log file further to said executing and upon detecting that no error is associated with said selected patch source code, updating said patch source code file or database with metadata associated with said patch source code.

According to some embodiments, said error object is a Java script object notation (JSON) object.

According to another aspect, the present invention concerns a computer program product comprising instructions for performing the method according to the invention when executed by one of more processors.

According to another aspect, the present invention concerns a computer readable storage medium having stored thereon instructions for causing one or more processors to perform the method of any one of claims 1 to 8.

According to another aspect, the present invention concerns a device for correcting errors in a software code file containing source code comprising one or more processors configured to perform alone or in combination automatic run of
parsing a log file obtained further to an execution of the software code contained in said software code file, to identify at least a data structure enabling the identification of one error message generated during the execution of said software code,
identifying, in the software code file, a location of software code lines corresponding to said at least one error message, said location being retrieved from information contained in said data structure,
matching information related to said at one error message with patch source code associated with said error message, said patch source code being contained in a patch source code file or a database,
modifying software code lines in said software code file at the identified location, using said patch source code.

According to some embodiments, the patch source code comprises an action and said modifying software code lines modify software code lines according to said action.

### BRIEF DESCRIPTION OF THE DRAWINGS

Further features and advantages of the present invention will become apparent from the following description of certain embodiments thereof, given by way of illustration only, not limitation, with reference to the accompanying drawings in which:

FIG. 1 illustrates a first example of a method according to an embodiment of the invention.

FIG. 2 illustrates an example of a parsing step according to an embodiment of the invention.

FIG. 3 illustrates an example of an identifying step according to an embodiment of the invention.

FIG. 4 illustrates an example of a matching step according to an embodiment of the invention.

FIG. 5 illustrates an example of a correcting step according to an embodiment of the invention.

FIG. 6 illustrates an example of a validating step according to an embodiment of the invention.

FIG. 7 illustrates an example of a patch source code according to an embodiment of the invention.

FIG. 8 illustrates a computer device which may be used to implement embodiments of the present invention.

### DETAILED DESCRIPTION OF EXAMPLE EMBODIMENTS

Methods and systems for automatically fixing errors and exceptions in application software are disclosed.

The present disclosure concerns a technical solution for providing an automatic correction of errors in a software code. The present disclosure can be applied for instance on script code that has been written for testing a software program but no limitation is attached to this kind of software.

By error, one can understand only error or error and exceptions. More precisely, usually an error is defined as a problem in the script code itself whereas an exception represents a problem in the software which is tested (by the test script). An exception means a failure in the tested application software whereas an error means an error in the test script. For sake of simplicity in the following description, error is used to cover both error and exception, unless specifically mentioned.

In the following description, the source code file is the application software that is under test and the log file is the result (or the output) generated further to the execution of the source code file. Of course several programming languages exist and no limitation is attached to the language used for coding the source code file, and no limitation is associated with the test platform as well.

In some implementations, the log file is an xml type file.

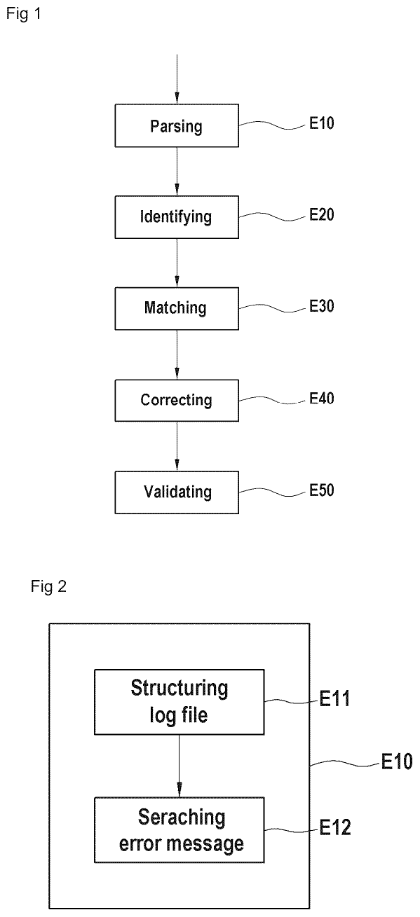

In some implementations, a first example of a method according to the present disclosure is represented on FIG. 1.

FIG. 1 represents an embodiment of a method according to the present disclosure.

It is assumed that before a parsing step E10, a log file has been obtained further to the execution of a software code file containing source code.

At step E10, the log file is parsed in order to search for at least one data structure enabling the identification of one error message.

According to some implementations, in order to conduct this search, one may use a search by keyword to detect the error messages. A simple search of words like “error”, “failure”, may conduct to a list of errors in the log file.

According to some implementations, the search may also be an index search, using some identifiers or tags which function is to identify these data structures in an efficient way. These data structures are functional in the sense that they control the parsing of the file and facilitate the access to data and therefore contribute to the technical effect of the present disclosure.

During this parsing, when a data structure identifying an error is found, thanks for instance to the syntax of the code file, code lines associated with the error may be extracted. This may lead to a list of errors in the form of data structures, containing for instance at least extracted lines of codes, and/or additional information such as lines describing the error.

In addition to extracting the data structures identifying the errors, an error object may be formed to describe the error, said object may comprise an error identifier and description information associated with said error object. The description information comprises a description of the error. Among others, an error may be described by the following information:
Error/Exception Name,
Error message accompanying the error,
Error Keyword (root cause of error),
Error Keyword arguments (parameters passed to the keyword),
Path to error keyword taken by the interpreter which may be useful in the case of nesting,
Error Keyword's source Library,
Path to error keyword library in terms of other libraries: this helps to identify the file where interpreter stopped,
Classification, indicating whether occurred error is at a code level or platform error
Index, indicating the uniqueness count of the keyword arguments combination: this helps to identify correct line in case of duplicates.

According to some implementations the error object may be structured according to Java script object notation (JSON).

Further to the parsing, identification is performed at step E20. During step E20, the identification of the location of the source code in the software code file, which generated the error, is performed. The location may be a set of lines numbers or a start and end number lines. The location may also be an identifier, a keyword, or any indicator that may link the error message in the log file and associated code of the software code file that generated the error in the log file during execution. The location information is therefore retrieved from the data structure identifying the error.

Said location information is added to the error object. The description information may be used to carry out the search to extract the location information such as filename and line numbers.

The descriptive information mentioned above is used to perform a search to extract the filename and line number.

At step E30, a matching of information related to said at least one data structure with patch source code is performed. The patch source code may be contained in a patch source code file or a patch database. Said patch source code file or patch database may be located locally on a test platform or remotely, on the cloud or on a remote server.

The patch source code file or patch database may comprise a set of predefined templates that contain each a set of code lines. Said set of code lines is used for correcting the error associated. Said template therefore contains the name of the error it may correct and the code used for correcting this error.

For one error message, one or several patches (templates) may be found in the patch source code file. Indeed, the matching may be performed using keyword searches, using for instance fuzzy logic and this can lead to the obtaining of more than one template. At the end, only one template should be selected to be used for fixing the detected error. So, a confidence score may be associated with each template during this matching. For instance, the confidence score may be a percentage representing the matching. The percentage may be representative of the numbers of words matching between the error object and a field in the template representing the error description. When referring to FIG. 8, the template comprises an “error message” field which may be structured as the error data structure or error object and the confidence score may be a matching between the data structure or error object and the error message field of the template.

A patch may be selected among the potential plurality of patches according to the confidence score. The patch having the highest confidence score may be selected.

In some implementations, a patch may only be selected if its confidence score is higher than a determined confidence score. For instance, a determined confidence score can be 20%. It all the patches that could be candidate for correcting the errors have a confidence score lower than 20%, no patch may be selected and a notification may be issued as an information that no patch has been selected.

At step E40, modification of the software code is performed for correcting the error is performed. For this, the information contained in the selected patch is used. According to the type of error and to the information contained in the patch, several correction types may be foreseen.

According to some implementations, an action may be comprised in the patch source code and said modifying software code lines modify software code lines according to said action.

In some implementations, the action may consist in replacing the source code referred to by the error object by the patch source code or by part of the lines of the patch source code.

In some implementations, the action may consist in replacing only some lines of the source code referred to by the error object by the lines or part of the lines of the patch source codes.

In some implementations, the action may consist in adding lines from the patch source code to the source code referred to by the error object. In addition, the patch source code may indicate where the lines to be added should be inserted, for instance before or after the line or code identified as the code which generated the error.

The software code lines is corrected in said software code file at the identified location, by using said patch source code.

In some implementations, the software code file is structured in a tree form and the patch is applied in this tree structure first and then into the software code file. The tree structure is generated by traversing the source code file in a particular order, as defined by the framework itself.

The patches are inserted into the tree at the identified location and once patching is done, the tree is traversed in the same order and the original source code file is overwritten with new contents.

When the action for correcting the error consists in replacing the code which generated the error, or part of it, by the patch, replacing the code which generated the error may be faster in the software code file. When the action for correcting the error consists in inserting code file, using a tree structured file for inserting the patch is faster.

In such implementations, the location information contained in the error object contains location information of the error in the tree-structured software code file.

Once the correction is applied, the updated software code with one or several patches correcting one or several errors may be executed and the steps E10 to E40 can be iterated again to detect and correct automatically additional errors.

In other implementations, further to the step of correcting, a validation is performed, step E50. This validation phase is preceded by an execution of the software code file (after step E40) and may consist first is parsing the log file obtained further to this execution to parse for the error or the plurality of errors for which a patch source code has been used to correct this or these errors.

The list of errors corrected during the previous iteration may have been stored for instance in a memory of a computer implementing the method. Execution status is checked in the log file. If no more error has been generated for a given former error, the patch used was the appropriate one and the correction performed with this patch was adapted to the correction of the error. In such a case, the software code file can be stored in the form of a new release with one or several errors less than the former stored release.

In some implementations, this validation may also update the confidence score associated with the patch that has been used for correcting the code that generated an error. The confidence score may therefore, contain also an indication of a success of correction and to this end, be updated according to a former correction of errors, said update being linked to the success of correction.

If an error has not been corrected, a notification may be generated that the correction applied with the selected patch could not solve the error.

According to some implementations, the parsing, step E10 of FIG. 1, may be implemented as illustrated by FIG. 2.

In order to accelerate the parsing of the log file to detect errors, the log file may be structured as a tree, step E11. Therefore during the parsing, if the parsing is based on a search by keyword, the keyword is only searched in a reduced size file instead of parsing the whole log file. During a step E12, the tree structure is parsed and errors are detected. By detecting errors, it is understood that according to implementations, several failed code keywords information can be searched. For instance, “error”, “failure”, “exception” can be searched.

Once one error keyword has been detected thanks to the keyword search for instance, an error message may be aggregated and associated with the keyword. In order to aggregate the error message, syntax elements of the log file may be used, and these syntax elements may be keywords such as “end” or may be tags, when the log file is an XML type log file for instance. The error message may therefore be composed of a number of lines of the log file containing the error keyword and contained within determined syntax elements or keywords enabling to select the essential lines to characterize the error message and form a description of the error message.

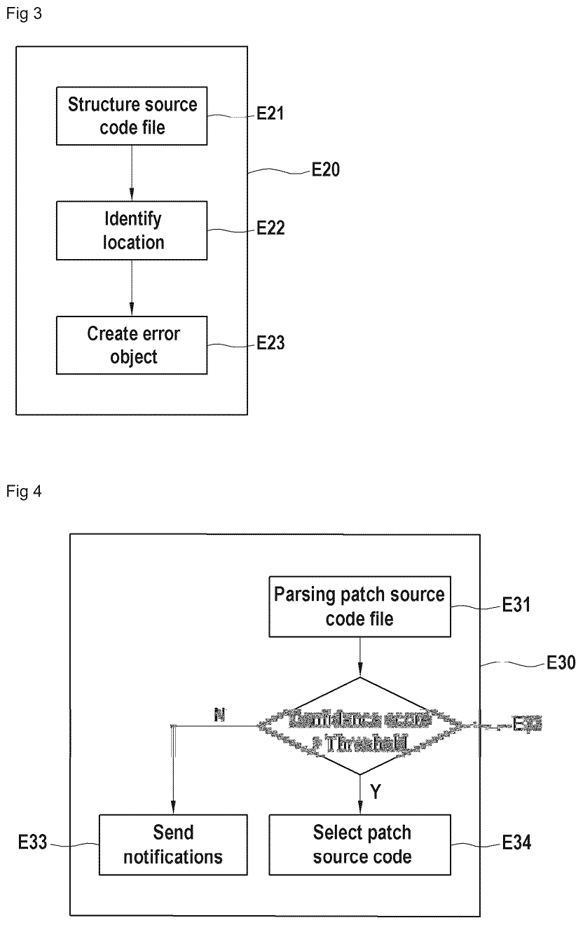

According to some implementations, the identifying step E20 of FIG. 1, may be implemented as illustrated by FIG. 3.

According to some implementations, step E20 may contain a step E21 of structuring the software code file in a tree structure.

According to other implementations, step E21 may be part of the parsing step as this step is used for obtaining a location information when said location information is related to a location information of the tree structured software code file.

In step E21, the software code file is structured as a tree, as is the log file as explained earlier in reference to step E11. As the content of the log file and the content of the software code file are different, the obtained tree structured code file may be different in terms of structure.

In a step E22, a location information may be determined which corresponds in some implementations to a location in the software code file of the source code which generated an error data structure in the log file.

In other implementations, the location information may correspond to a location in the tree structured code file of the source code which generated an error data structure in the log file.

In other implementations, the location information may correspond both to the location in the tree structured code file or in the software code file or in addition to the location in the tree structured log file, contain a pointer into the software code file.

As mentioned earlier, the location may be a line number, a syntax element, a pointer in the file, a file name.

At step E23, an error object is created which may comprise an error identifier, error description and the location as identified at step E20.

It has to be noted that step E20 and E30 can be done in any order. When an error object is created first, it is updated with the location further to the location identification when the location identification is created after the object creation.

The error description may comprise a set of lines of the log file, which may be in a close vicinity of the error keyword found. As mentioned earlier in reference to the creation of the error message, the description can be a set of code lines identified as comprised between determined syntax elements and can be the content of the data structure as described earlier or a subset of the content of the data structure comprising a selection of filtered information contained in the data structure.

The object obtained may be an object compliant with Java Script Object Notation format (JSON).

According to some implementations, the matching step E30 of FIG. 1, may be implemented as illustrated by FIG. 4.

At a step E31, the patch source code is parsed and a search is launched using information from one error object. This can be done for all the error objects or error data structures.

The information from the error object or data structure that is used for parsing may only be the error identifier or in order to be more accurate in finding the appropriate patch, the description of the error in the error object or data structure.

The parsing may be based on keyword search and uses similarity measures between the patch templates contained the patch source code file or patch database and the description of the data structure or error object.

Several patch templates for one data structure or error object may be obtained at the end of the parsing.

A patch template may be associated with a confidence score once the matching is done with one data structure. The confidence score may be directly linked to the similarity measure. The more similarities exist between the patch template and the data structure or error object, the highest the confidence score may be.

As mentioned earlier, the similarity measurement may be based on the number of common words between the data structure or error object (or the description of the data structure or error object) and an obtained patch template.

At step E32, if none of the obtained patches has a confidence score lower than a determined value, such as 20%, then a notification can be sent, step E33, to inform that no patch template is found or exists in the patch source code or database.

At step E32, if at least a patch template has a confidence score higher than the determined value, a set of patch source codes having a confidence score higher than the predetermined value is selected.

At step E34, the patch source code having the highest confidence score is selected to be used for correcting the error.

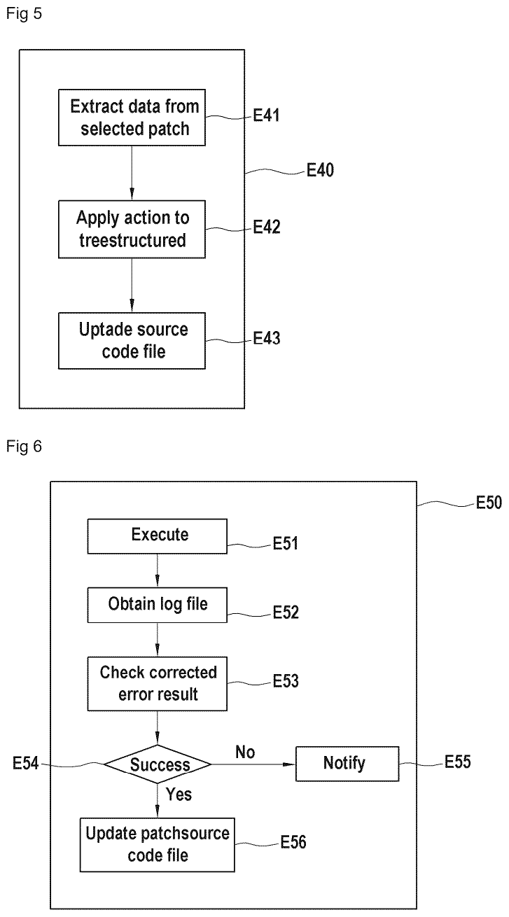

According to some implementations, the correcting step E40 of FIG. 1, may be implemented as illustrated by FIG. 5.

Once one patch has been obtained further to step E30, the code source file is corrected using said selected patch source code information and the location information contained the data structure or error object. The location information may be used to detect the corresponding source code to be corrected, either directly into the source code or going first through the tree structured software code file.

During step E41, data may be extracted from said patch template. The extracted data is used to correct the source code according to the error.

The correction may consist in an action, step E42 selected among one or several of the following actions:
replacing the source code at the origin of the error, by the error patch template
modifying the source code at the origin of the error, by information extracted from the patch template,
adding to the source code at the origin of the error, information extracted from the patch template or information derived from said patch template.

In some implementations, the corrected action is performed first on the tree-structured software code file and then it is automatically updated into the software code file.

In other implementations, the corrected action is performed directly in the software code file.

Step 43 covers both of the above mentioned alternatives. This may be possible according to the location information, when the location information contains location information related to the tree structure software code file, or location related to the software code file or both.

According to some implementations, the validating step E50 of FIG. 1 may be implemented as illustrated by FIG. 5.

Further to the correction of an error or several errors, an automatic execution of the software code file may be launched, step E51, in order to validate the correction that was performed on one or several errors. A log file is obtained from this execution, step E52.

In a step E53, the log file is parsed in order to search for the one or several errors that were previously present in the former log file (obtained from the previous execution). During a step E54, if the error that was corrected is no more present, then at step E56, an update of the patch source code is performed. This update may consist in updating the patch source code file or database with metadata associated with said patch source code. This metadata may be related to the confidence score, such as an update of the confidence score or may be additional data related to the patch code.

If the error remains, it is detected during step E54 and a notification is sent in order to inform about the non-correction.

As mentioned earlier, the validation step can also include storing a new release of the software code file further to the correction of an error. This new release is then used for the next iterations of the method.

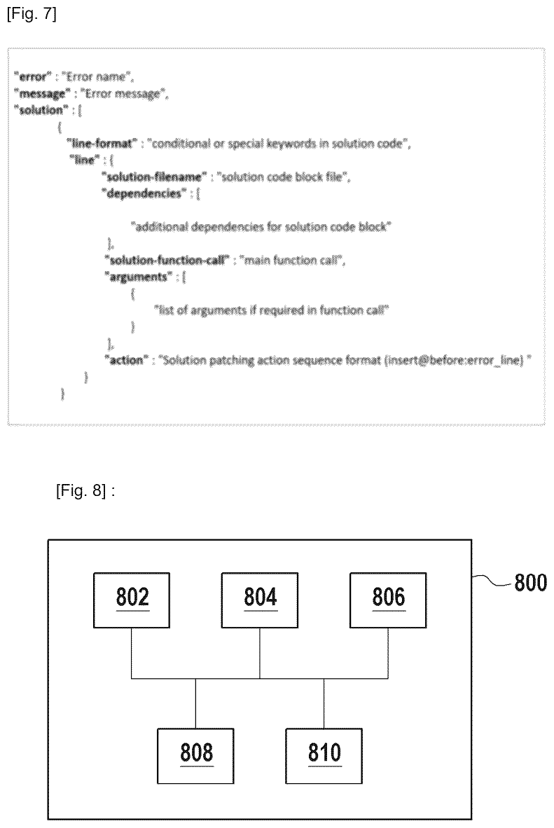

FIG. 7 illustrates an example of a batch template according to an example of the present disclosure. This example is a general overview of a batch template which is adapted to the error correction generally. The batch template comprises
a title field in the section “error” where the name of the error is associated with the template
a message field comprising the data structure for which solution is applicable,
a body comprising the code (a collection of source code lines) for correcting the error, as explained hereafter:
Solution: this is a collection of lines to be inserted and each line is governed by a sub-object (below)
   a. Line-format: normal or conditional;
      i. If “normal” then no extra processing is required, just patch where needed,
      ii. If “Conditional”, it means that the solution slightly changes the content if conditions are met or not met,
   b. Line: this is an object comprising the solution code for correcting the error
      i. Solution-filename: Indicates the name and or location of a source code file comprising the solution to correct the error,
      ii. Dependencies: Indicates which additional resources need to be downloaded in addition to the solution-file-source to correct the error,
      iii. Solution-function-call: indicates, in the solution file source indicated above, which specific function must be called and how to call the function,
      iv. Arguments: what are the parameters that need to be passed to the solution function that is called,
      v. Action: how to inject the solution function call into the code: the action may be one among insert, replace, append and also where to perform the action.

FIG. 8 illustrates a computer device 800 which may be used to implement implementations of the present invention. Specifically, the above-described steps may individually or collectively be implemented using a computer device such as computer device 800.

As shown in FIG. 8, computer device 800 includes a processor 802, a read-only memory (ROM) 804, a random access memory (RAM) 806, a non-volatile memory 808, and communication means 810 (i.e., a sender and a receiver) for communicating with other devices or for instance the patch database or file.

The ROM 804 of the computer device 800 may store a computer program including instructions that when executed by processor 802 cause processor 802 to perform acts of the present invention. The acts may include one or more of the acts described above in FIGS. 1 to 6.

1. A method for modifying a software code file containing source code, the method comprising automatically performing:
execution of said software code file,
parsing a log file obtained further to the execution of the software code contained in said software code file, to identify at least a data structure enabling the identification of one error message generated during the execution of said software code,
identifying, in the software code file, a location of software code lines corresponding to said at least one error message, said location being retrieved from information contained in said data structure,
matching information related to said at least one error message with patch source code associated with said error message, said patch source code being contained in a patch source code file or a patch database, and
modifying software code lines in said software code file at the identified location, using said patch source code.

2. The method of claim 1 wherein said patch source code comprises an action and said modifying software code lines modify software code lines according to said action.

3. The method of claim 1 wherein said parsing comprises:
structuring said log file in tree structure, and
searching said at least one error message based on an index search in said tree-structured log file.

4. The method of claim 1 further comprising structuring said software code file in tree structure.

5. The method of claim 3, further comprising, creating for the at least one data structure, from said tree-structured log file, an error object comprising an error identifier and description information associated with said error object and said location information.

6. The method of claim 5 wherein said matching comprises
parsing said patch source code file or patch database to retrieve at least one patch source code according to similarity measurement between said error object and said patch source code,
associating a confidence score to said at least retrieved patch source code, and
upon a determination that said at least one confidence score is above a determined confidence score, selecting patch source code according to the confidence score,
and wherein said modifying comprises
correcting said software code lines associated with said data structure by said selected patch source code using location information of said error object.

7. The method of claim 6 wherein said correcting said software code lines correct said software code lines in said tree-structured software code file.

8. The method of claim 6, further comprising, subsequent to the correcting:
executing said software code file,
parsing said obtained log file further to said executing, and
upon detecting that no error is associated with said selected patch source code, updating said patch source code file or database with metadata associated with said patch source code.

9. The method of claim 5, wherein said error object is a Java script object notation (JSON) object.

10. (canceled)

11. A non-transitory, computer readable storage medium having stored thereon instructions which, when executed by a processor, cause the processor to implement the method of claim 1.

12. A device for correcting errors in a software code file containing source code, the device comprising one or more processors configured to, alone or in combination, automatically perform:
parsing a log file obtained further to an execution of the software code contained in said software code file, to identify at least a data structure enabling the identification of one error message generated during the execution of said software code,
identifying, in the software code file, a location of software code lines corresponding to said at least one error message, said location being retrieved from information contained in said data structure,
matching information related to said at one error message with patch source code associated with said error message, said patch source code being contained in a patch source code file or a database, and
modifying software code lines in said software code file at the identified location, using said patch source code.

13. The device of claim 12 wherein said patch source code comprises an action and said modifying software code lines modify software code lines according to said action.
